(19) United States
(12) Patent Application Publication
(10) Pub. No.: US 2026/0183744 A1
(43) Pub. Date: Jul. 2, 2026

(54) BIOSORBENT FOR BIODIESEL WASTEWATER TREATMENT

(71) Applicant: KING ABDULAZIZ UNIVERSITY, Jeddah (SA)

(72) Inventors: Naved AZUM, Jeddah (SA); Niraj S. TOPARE, Pune (IN); Anish KHAN, Jeddah (SA); Malik Abdul RUB, Jeddah (SA); Khalid Ahmed ALZAHRANI, Jeddah (SA); Abdullah M. ASIRI, Jeddah (SA)

(73) Assignee: KING ABDULAZIZ UNIVERSITY, Jeddah (SA)

(21) Appl. No.: 19/003,051

(22) Filed: Dec. 27, 2024

(51) Int. Cl. B01J 20/24; B01J 20/32; C02F 3/34; C02F 101/32

(52) U.S. Cl. CPC B01J 20/24; B01J 20/3206; C02F 3/348; C02F 2101/32

(57) ABSTRACT

An active biosorbent that includes a support including a seed pod from a plant in the genus Delonix and a bacterium in the genus Bacillus disposed on the support and a method of its preparation. The active biosorbent is used in a method of removing an organic pollutant from water. The method may involve the biodegradation of the organic pollutant by the bacterium.

### STATEMENT OF ACKNOWLEDGEMENT

Support from King AbdulAziz University and the government of Saudi Arabia under grant number IFPP-20-691-2022 is gratefully acknowledged.

### BACKGROUND

### Technical Field

The present disclosure is directed towards an active sorbent material, more particularly, towards a biosorbent for treating biodiesel wastewater.

### Description of Related Art

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly nor impliedly admitted as prior art against the present invention.

Biodiesel is an alternative fuel for diesel engines that can be made from virtually any oil or fat feedstock. Biodiesel was developed to solve vast economic and environmental problems related to the use of fossil fuel and petroleum as primary fuel source. However, large quantities of water are necessary for biodiesel production, generating a high volume of effluent waste. Several different technologies, and methods such as chemical, biological, and physical are used to treat biodiesel wastewater. Further, certain biological processes are also used for treating biodiesel wastewater. Biological processes may be efficient and economical, but has certain limitations as they may generate large amounts of low-density sludge that has low decomposition efficiency, rendering the above approach time and storage volume consuming.

Chemical and physical processes are alternative potential procedures for treating wastewater from biodiesel production plants. Among the several chemical and physical methods utilized, the adsorption process is one of the most effective methods. Different adsorbents and commercial activated carbon are preferred sorbent treatment, but not widely used because of high cost. Conventional biodiesel treatment process includes technologies such as, but not limited to, coagulation flocculation, biodegradation, and adsorption. Coagulation flocculation is simple and economically feasible, however, it generates high amounts of sludge, leading to handling and disposal problems. Biodegradation is an economically feasible and environmentally acceptable treatment, but biodegradation is a slow process and in addition, maintaining an optimal environment and nutrition requirement for biodegradation may be challenging. Adsorption may be more costly and may be more challenging to achieve high efficiency. Moreover, regeneration of adsorbents used in adsorption processes may prove to be economically taxing and may result in loss of the adsorbent. Specific sub-types of these technologies used for biodiesel wastewater management include membrane separations, ion, ion-exchange, oxidation, advanced oxidation process, selective biomass, and biosorbent biomass.

Many technologies and processes have been developed to tackle the above stated problem statement(s), however, there is still a requirement for low-cost adsorbents, synthesized from a plurality of sources and methods. Hence, each of the aforementioned processes and methods, described herein, suffers from one or more drawbacks hindering their adoption.

Accordingly, it is one object of the present disclosure to provide an active biosorbent for biodiesel wastewater management, that can address the limitations with existing technologies.

### SUMMARY

According to a first aspect, the present disclosure relates to an active biosorbent cartridge comprising a support comprising a seed pod from a plant in the genus Delonix in powder form and a bacterium in the genus Bacillus disposed on the support, and a container in which the active biosorbent is disposed comprising a porous plug configured to contain the active biosorbent in the container, wherein the active biosorbent has a weight ratio of the support to the bacterium of 1:1 to 25:1.

In some embodiments, the plant in the genus Delonix is Delonix regia.

In some embodiments, the seed pod from a plant in the genus Delonix is in the form of a ground powder.

In some embodiments, the seed pod from a plant in the genus Delonix includes 25 percent by weight (wt. %) to 45 wt. % cellulose, 25 wt. % to 45 wt. % hemicellulose and 10 wt. % to 25 wt. % lignin, each based on a total weight of seed pod from a plant in the genus Delonix.

In some embodiments, the bacterium in the genus Bacillus is Bacillus subtilis.

In some embodiments, the active biosorbent has an adsorption capacity of 75 mg biodiesel/g to 200 mg biodiesel/g.

In some embodiments, the support further includes a nutrient mixture including a bacterial growth medium.

The present disclosure also relates to a method of removing an organic pollutant from water. In some embodiments, the method includes contacting a contaminated water with the active biosorbent and collecting a purified water. In some embodiments, the organic pollutant is at least one selected from the group consisting of a dye, a phenol, a polycyclic aromatic hydrocarbon, an herbicide, a pesticide, a persistent organic pollutant, and a biodiesel.

In some embodiments, the organic pollutant is a biodiesel.

In some embodiments, the plant in the genus Delonix is Delonix regia.

In some embodiments, the bacterium is in the genus Bacillus is Bacillus subtilis.

In some embodiments, the active biosorbent has an adsorption capacity of 75 mg biodiesel/g to 200 mg biodiesel/g.

In some embodiments, contacting is performed by flowing the contaminated water through a bed including the active biosorbent at a flowrate of 10 milliliters per minute (mL/min) to 20 mL/min, the bed including the active biosorbent having a length of 2.5 cm to 25 cm and a diameter of 1 cm to 5 cm.

In some embodiments, the method has a removal efficiency of 90% to 99% based on an initial amount of organic pollutant present in the contaminated water.

In some embodiments, the method further includes eluting, from the contaminated biosorbent using an elution solution, at least one selected from the group consisting of the organic pollutant and a biodegradation product of the organic pollutant.

In some embodiments, the method further includes supplementing the active biosorbent by contacting the active biosorbent with a nutrient solution including a bacterial growth medium.

The present disclosure also relates to a method of forming the active biosorbent. In some embodiments, the method includes combining the support including a seed pod from a plant in the genus Delonix and the bacterium in the genus Bacillus.

In some embodiments, the method further includes forming the support by milling the seed pod from a plant in the genus Delonix to form a seed pod powder and mixing the seed pod powder with nutrient mixture including a bacterial growth medium, where the plant in the genus Delonix is Deonix regia.

In some embodiments, the combining is performed by mixing the support with a pellet of the bacterium in the genus Bacillus.

In some embodiments, the combining is performed by inoculating the support with an inoculation solution including the bacterium in the genus Bacillus and drying.

The foregoing general description of the illustrative embodiments and the following detailed description thereof are merely exemplary aspects of the teachings of this disclosure, and are not restrictive.

### BRIEF DESCRIPTION OF THE DRAWINGS

A more complete appreciation of this disclosure and many of the attendant advantages thereof will be readily obtained as the same becomes better understood by reference to the following detailed description when considered in connection with the accompanying drawings, wherein:

FIG. 1A is a schematic flow chart of a method of forming an active biosorbent, according to certain embodiments.

FIG. 1B is a schematic flow chart of a method of removing an organic pollutant from water, according to certain embodiments.

FIG. 2 is a schematic diagram depicting a design for an exemplary continuous column, according to certain embodiments.

FIG. 3 is a graph depicting an effect of inlet concentrations on efficiency of treatment for biodiesel wastewater, according to certain embodiments.

FIG. 4 is a graph depicting an effect of bed height on efficiency of treatment for biodiesel wastewater, according to certain embodiments.

FIG. 5 is a graph depicting an effect of flow rates on efficiency of treatment for biodiesel wastewater, according to certain embodiments.

### DETAILED DESCRIPTION

In the drawings, like reference numerals designate identical or corresponding parts throughout the several views. Further, as used herein, the words “a”, “an” and the like generally carry a meaning of “one or more”, unless stated otherwise.

Furthermore, the terms “approximately,” “approximate”, “about” and similar terms generally refer to ranges that include the identified value within a margin of 20%, 10%, or preferably 5%, and any values therebetween.

As used herein, the term ‘support’ refers a substrate or medium for the growth and/or establishment of bacterium.

As used herein, the term “optical density (OD)” refers to the measure of how much a substance absorbs light. In microbiology, it is commonly used to estimate the concentration of cells in a culture. Specifically, OD is often measured at a wavelength of 600 nm (OD600), where the turbidity of the culture indicates the number of cells present.

As used herein, the term “elution solution” refers to a liquid/a solution used to remove or wash out bound substances from a solid support, such as a column or membrane, during purification or separation processes.

As used herein, “biodegradation products” refer to product that results from the breakdown of organic materials by biological processes, primarily involving microorganisms like bacteria, algae and fungi. These organisms metabolize organic pollutants or other biodegradable substances and convert them into simpler compounds.

According to a first aspect, the present disclosure relates to an active biosorbent. In some embodiments, the active biosorbent (also referred to as a biosorbent) includes a support including a seed pod from a plant belonging to the genus Delonix, and a bacterium in the genus Bacillus disposed on the support. The active biosorbent of the present disclosure may be advantageous in being environmentally friendly, efficient, inexpensive, and can help in wastewater treatment by circumventing the drawbacks of the art.

In some embodiments, the seed pod is obtained from a plant belonging to the genus Delonix. Suitable examples of plants belonging to the genus Delonix include, but are not limited to, Delonix baccal, Delonix boiviniana, Delonix brachycarpa, Delonix decaryi, Delonix edulis, Delonix elata (L.), Delonix floribunda, Delonix pumila, Delonix regia, Delonix tomentosa, and/or Delonix velutina. In some embodiments, the plant in the genus Delonix is Delonix regia. In general, any suitable variety of Delonix regia may be used, including sub-species, cultivars, hybrids, and/or genetically modified varieties of Delonix regia.

Delonix regia, or the flame tree, may be advantageous to use in biosorption processes due to factors such as the high surface area of its seed pods and the fact that it is found abundantly in nature. As it is widely available, it is both economical and sustainable. Additionally, the seed pod includes several chemical functional groups that may enhance the adsorption of various organic pollutants and heavy metals through mechanisms such as ion exchange, complexation, or electrostatic interactions. Delonix seed pods are lignocellulosic materials that can contain a complex mix of cellulose, hemicellulose, and lignin. These components may provide a structure suitable for adsorption of various pollutants.

In some embodiments, the seed pod from a plant in the genus Delonix includes 25 wt. % to 45 wt. % cellulose, based on a total weight of the seed pod from a plant in the genus Delonix. For example, the seed pod may include 25 wt. %, 25.5 wt. %, 26 wt. %, 26.5 wt. %, 27 wt. %, 27.5 wt. %, 28 wt. %, 28.5 wt. %, 29 wt. %, 29.5 wt. %, 30 wt. %, 30.5 wt. %, 31 wt. %, 31.5 wt. %, 32 wt. %, 32.5 wt. %, 33 wt. %, 33.5 wt. %, 34 wt. %, 34.5 wt. %, 35 wt. %, 35.5 wt. %, 36 wt. %, 36.5 wt. %, 37 wt. %, 37.5 wt. %, 38 wt. %, 38.5 wt. %, 39 wt. %, 39.5 wt. %, 40 wt. %, 40.5 wt. %, 41 wt. %, 41.5 wt. %, 42 wt. %, 42.5 wt. %, 43 wt. %, 43.5 wt. %, 44 wt. %, 44.5 wt. %, or 45 wt. % cellulose, based on a total weight of seed pod.

In some embodiments, the seed pod from a plant in the genus Delonix includes 25 wt. % to 45 wt. % hemicellulose, based on a total weight of the seed pod from a plant in the genus Delonix. For example, the seed pod may include 25 wt. %, 25.5 wt. %, 26 wt. %, 26.5 wt. %, 27 wt. %, 27.5 wt. %, 28 wt. %, 28.5 wt. %, 29 wt. %, 29.5 wt. %, 30 wt. %, 30.5 wt. %, 31 wt. %, 31.5 wt. %, 32 wt. %, 32.5 wt. %, 33 wt. %, 33.5 wt. %, 34 wt. %, 34.5 wt. %, 35 wt. %, 35.5 wt. %, 36 wt. %, 36.5 wt. %, 37 wt. %, 37.5 wt. %, 38 wt. %, 38.5 wt. %, 39 wt. %, 39.5 wt. %, 40 wt. %, 40.5 wt. %, 41 wt. %, 41.5 wt. %, 42 wt. %, 42.5 wt. %, 43 wt. %, 43.5 wt. %, 44 wt. %, 44.5 wt. %, or 45 wt. % hemicellulose, based on a total weight of seed pod.

In some embodiments, the seed pod from a plant in the genus Delonix includes 10 to 25 wt. % lignin, based on a total weight of the seed pod from a plant in the genus Delonix. For example, the seed pod may include 10 wt. %, 10.5 wt. %, 11 wt. %, 11.5 wt. %, 12 wt. %, 12.5 wt. %, 13 wt. %, 13.5 wt. %, 14 wt. %, 14.5 wt. %, 15 wt. %, 15.5 wt. %, 16 wt. %, 16.5 wt. %, 17 wt. %, 17.5 wt. %, 18 wt. %, 18.5 wt. %, 19 wt. %, 19.5 wt. %, 20 wt. %, 20.5 wt. %, 21 wt. %, 21.5 wt. %, 22 wt. %, 22.5 wt. %, 23 wt. %, 23.5 wt. %, 24 wt. %, 24.5 wt. %, or 25 wt. % lignin, based on a total weight of seed pod.

These weight percentages may be calculated based on a dry weight of the seed pod. The dry weight of the seed pod and/or the weight percentages of the various components can be determined for a whole seed pod or a seed pod that has been ground or milled as described below. It should be noted that the exact percentages of cellulose, hemicellulose, and lignin can vary based on factors like growing conditions and maturity of the seed pods.

In some embodiments, the Delonix regia seed pods can include other components normally found in plant products. Examples of such other chemical components include, but are not limited to saponins, flavonoids, terpenes, cardenolides, steroids, glycosides, and tannins.

Saponins are a class of plant glycosides in which water-soluble sugars are attached to either a lipophilic steroid or triterpenoid. This hydrophobic-hydrophilic asymmetry means that these compounds have the capacity to lower surface tension and are soap-like, similar to surfactants. Examples of saponins are aescin, araloside A, astragaloside, bacopaside, bacosides I-XI, chaconine, charantin, daucosterol, digitonin, esculeoside A, ginsenoside, glycyrrhizin, gypenoside, A-hederin, holothurin, momordin, osladin, protodioscin, pseudoginsenoside, solanine, and ziziphin.

Flavonoids are a group of naturally occurring polyphenolic compounds characterized by the flavan nucleus structure depicted below.

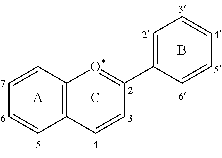

It is worth noting that the phenyl ring labeled “B” in the above image may be connected to either the 2 position as shown or to the 3 position of the “C” ring. Examples of flavonoids include, but are not limited to anthoxanthins, flavans, anthocyanidins, aurones, and chalcones. Examples of anthoxanthins include flavones such as primuletin, chrysin, tectochrysin, primentin, apigenin, acacetin, genkwanin, echioidinin, baicalein, oroxylon, negletein, norwogonin, wogonin, geraldone, tithonine, luteolin, chrysoeriol, diosmetin, pillion, velutin, norartocarpetin, artocarpetin, scutellarein, hispidulin, sorbifolin, pectolinarigenin, cirsimaritin, mikanin, isocutellarein, zapotinin, zapotin, cerrosillin, alnetin, tricin, corymbosin, nepetin, pedalitin, nordifloretin, jaceosidin, cirsiliol, eupatilin, cirsilineol, eupatorin, sinensetin, hypolaetin, onopordin, wightin, nevadensin, xanthomicrol, tangeretin, serpyllin, sudachitin, acerosin, hymenoxin, nobiletin, and scaposin; flavonols such as 3-hydroxyflavone, azaleatin, fisetin, galangin, gossypetin, isorhamnetin, kaempferide, kaempferol, morin, myricetin, natsudaidain, pachypodol, quercetin, rhamnazinm, and rhamnetin; isoflavones such as daidzein, genistein, and orobol; and neoflavonoids such as dalbergichromene, calophyllolide, coutareagenin, dalbergin, and nivetin. Examples of flavans include, but are not limited to flavanols such as catechin, epiafzelechin, fisetinidol, guibourtinidol, mesquitol, robinetinidol, apiforol, and luteoforol; flavan-3,4-diols such as leucocyanidin, leucodelphinidin, leucofisetinidin, leucomalvidin, leucopelargonidin, leucopeonidin, leucorobinetinidin, melacacidin, and teracacidin; flavanones such as blumeatin, butin, eriodictyol, hesperetin, hesperidin, homoeriodictyol, isosakuranetin, naringenin, naringin, pinocembrin, poncirin, sakuranetin, sakuranin, sterubin, and pinostrobin; and flavanonols such as taxifolin, aromadedrin, and engeletin. Examples of an anthocyanidins include, but are not limited to aurantinidin, capensinidin, cyanidin, delphinidin, europinidin, hirsutidin, malvidin, pelargonidin, peonidin, petunidin, pulchellidin, rosinidin, apigeninidin, columnidin, diosmetinidin, luteolinidin, tricetinidin, apigeninidin, and guibourtinidin. Examples of aurones include, but are not limited to aurone, 4′-chloro-2-hydroxyaurone, 4′-chlroaurone, aureusidin, sulfuretin (6,3′,4′-trihydroxyaurone), hispidol (6,4′-dihydroxyaurone), and leptosidin. Examples of chalcones include, but are not limited to aurentiacin A, aurentiacin B, 2′,6′-dihydroxy-4′-methoxy-3′,5′-dimethyldihydrochalcone, rubone, bakuchalcone, dihydrochalcone, lapathinol, lapathone, brackenin, mixtecacin, 2′,6′-dihydroxy-4′-methoxydihydrochalcone, isoliquiritin, licuraside, xanthangelols B through E, ponganone I and II, stipulin, 3,3′-dihydroxychalcone, spinochalcone A, spinochalcone B, flemistrictin A, calythropsin, dihydrocalythropsin, pedicin, fissistin, isofissistin, munchiwarin, prorepensin, lonchocarpin, and cardamonin.

Examples of terpenes include, but are not limited to carotenes such as α-carotene, β-carotene, γ-carotene, δ-carotene, ε-carotene, lycopene, neurosporene, phytofluene, and phytoene; and xanthophylls such as canthaxanthin, cryptoxanthin, zeaxanthin, astaxanthin, lutein, rubixanthin.

Examples of cardenolides include, but are not limited to acetyldigitoxins, acetyldigoxins, cymarine, digitoxin, digitoxigenin, digoxigenin, digoxin, medigoxin, neoconvalloside, ouabain, strophanthins, and strophanthidin.

Examples of steroids include, but are not limited to brassinosteroids such as Brassinolide, 28-homobrassinolide, dolicholide, 28-homodolicholide, 28-norbrassinolide, 2-deoxybrassinlide, castasterone, dolichosterone, 2-epicastasterone, 28-nortyphasterol, typhasterol, secasterone, and secasterol, and phytosterols such as β-sitosterol, campesterol, cholesterol, stigmasterol, stigmastanol, ergosterol, lupeol, and cycloartenol.

Glycosides are molecules in which a sugar group is bonded through its anomeric carbon to another group via a glycosidic bond. Glycosides can be linked by an O- (an O-glycoside), N- (a glycosylamine), S- (a thioglycoside), or C- (a C-glycoside) glycosidic bond. A glycosidic bond refers to a bond formed between the hemiacetal or hemiketal group of a saccharide (or a molecule derived from a saccharide) and, in the case of an O-glycosidic bond the oxygen atom of a hydroxyl group of some compound such as an alcohol. In the case of an S-glycosidic bond, the bond is formed with a sulfur atom of a suitable sulfur-containing functional group. In the case of an N-glycosidic bond, the bond is formed with a nitrogen atom of a suitable nitrogen-containing functional group. In the case of a C-glycosidic bond, the bond is formed with a carbon atom. Examples of glycosides include, but are not limited to spinacetin 3-O-β-d-glucopyranosyl(1→6)-[β-d-apiofuranosyl(1→2)]-β-d-glucopyranoside; patuletin 3-O-β-d-(2″feruloylglucopyranosyl) (1→6)-[β-d-apiofuranosyl(1→2)]-β-d-glucopyranoside; spinacetin 3-O-β-d-(2″-p-coumaroylglucopyranosyl) (1→6)-[β-d-apiofuranosyl(1→2)]-β-d-glucopyranoside; spinacetin 3-O-β-d-(2″feruloylglucopyranosyl) (1→6)-[β-d-apiofuranosyl(1→2)]-β-d-glucopyranoside; spinacetin 3-O-β-d-(2″feruloylglucopyranosyl) (1→6)-β-d-glucopyranoside; jaceidin 4′-glucuronide; 5,3′,4′-trihydroxy-3-methoxy-6:7-methylenedioxyflavone 4′-glucuronide; 5,4′-dihydroxy-3,3′-dimethoxy-6:7-methylenedioxyflavone 4′-glucuronide; patuletin 3-glucosyl(1→6)-[apiosyl(1→2)]glucoside; and patuletin and spinacetin 3-gentiobiosides.

Tannins are water-soluble polyphenols, typically having molecular weights of 500 to 20,000 Da. Typically, tannins are formed from repeat units of gallic acid or flavan-3-ol. Examples of tannins include, but are not limited to, ellagitannins tannins such as punicalagins, castalagins, vescalagins, castalins, casuarictins, grandinins, punicalins, roburin As, tellimagrandin IIs, and terflavin Bs; and gallotannins such as digalloyl glucose and 1,3,6-trigalloyl glucose.

In some embodiments, the support is substantially free of saponins, flavonoids, terpenes, cardenolides, steroids, glycosides, and tannins. Such components may be removed from the seed pods using any suitable technique known to one in the art. For example, the seed pods may be treated with a solvent to extract one or more of the saponins, flavonoids, terpenes, cardenolides, steroids, glycosides, and tannins.

In some embodiments, in addition to the seed pods, other parts of a plant in the genus Delonix can be included in the support. Examples of such other parts include, but are not limited to, leaves, stems, roots, bark, flowers, fruits, buds, and whole plant. In some embodiments, the support is substantially free of leaves, stems, roots, bark, flowers, fruits, and buds from the plant in the genus Delonix.

In some embodiments, the seed pods may be dried prior to use in forming the biosorbent. In some embodiments, the seed pods may be milled or ground to small particles. In some embodiments, the seed pods are milled or ground to have a mean particle size of 5 to 500 μm. For example, in some the seed pods may be milled or ground to have a mean particle size of 5 μm, 10 μm, 15 μm, 20 μm, 25 μm, 30 μm, 35 μm, 40 μm, 45 μm, 50 μm, 55 μm, 60 μm, 65 μm, 70 μm, 75 μm, 80 μm, 85 μm, 90 μm, 95 μm, 100 μm, 105 μm, 110 μm, 115 μm, 120 μm, 125 μm, 130 μm, 135 μm, 140 μm, 145 μm, 150 μm, 155 μm, 160 μm, 165 μm, 170 μm, 175 μm, 180 μm, 185 μm, 190 μm, 195 μm, 200 μm, 225 μm, 250 μm, 275 μm, 300 μm, 325 μm, 350 μm, 375 μm, 400 μm, 425 μm, 450 μm, 475 μm, or 500 μm. In some embodiments, the seed pods are milled or ground to a powder. In general, the grinding or milling may be performed by any suitable technique or with any suitable equipment known to one of ordinary skill in the art. Examples of such techniques include, but are not limited to, grinding, ball milling, chopping, pulverizing, crushing, pounding, mincing, shredding, smashing, and fragmenting. In some embodiments, the milling may take place using a mill, ball mill, rod mill, autogenous mill, cutting mill, semi-autogenous grinding mill, pebble mill, buhrstone mill, burr mill, tower mill, vertical shaft impactor mill, a low energy milling machine, grinder, pulverizer, mortar and pestle, blender, crusher, or other implement used to reduce a material to small particles. In some embodiments, the seed pod is ground, milled, or otherwise reduced to smaller particles following the drying. In some embodiments, the seed pod is in the form of a powder. Use of this powdered form may be advantageous increasing the surface area of the seed pods, maximizing the active sites available for binding contaminants/pollutants. This may be advantageous for increasing the effectiveness of the active biosorbent. In some embodiments, the seed pods can be further processed/modified via chemical activation/surface modification to enhance its biosorption capacity, such as solvent treatment as described above.

In some embodiments, the support includes a nutrient mixture. In general, the nutrient mixture may include components and nutrients to facilitate growth of a microorganism present in or on the support, such as the bacterium in the genus Bacillus. Examples of substances the nutrient mixture may include are nitrogen sources such as ammonium salts or urea; phosphorus sources such as monoammonium phosphate (MAP) or diammonium phosphate (DAP); carbon sources such as glucose, sucrose, maltose, and the like; yeast extract, trace elements and minerals such as iron, manganese, zinc, copper, and cobalt; calcium; magnesium; vitamins such as thiamine, riboflavin, and niacin, buffering agents such as sodium bicarbonate; pH adjusters such as citric acid or sodium hydroxide; bonemeal; amino acids or salts thereof; protein isolates or hydrolysates; and mixtures thereof.

In some embodiments, the support further includes a nutrient mixture including a bacterial growth medium. In general, a bacterial growth medium refers to a specialized substance or composition that provides necessary nutrients and environmental conditions to support growth, reproduction, and metabolic activity of any bacteria. The bacterial growth medium typically contains a mixture of water, essential salts, carbon sources, nitrogen sources, vitamins, amino acids, and/or other organic or inorganic compounds required for bacterial cell growth. The composition of the bacterial growth medium may be adjusted to cater to specific bacterial strains or species by altering factors such as pH, concentration of various components, salt level, ionic strength, the concentration of the various components, and/or the presence of selective agents. Bacterial growth media may be in any suitable form, such as a liquid broth, a solid medium such as agar, or a semi-solid medium. Some of the examples for the bacterial growth medium include, but are not limited to, nutrient agar, nutrient broth, tryptic soy agar, tryptic soy broth, Luria-Bertini agar and broth, blood agar, potato dextrose agar, potato dextrose broth, Mannitol Egg Yolk Polymyxin (MYP) agar, Modified Nutrient Sporulation Medium (NSM), and the like.

Including the nutrient mixture in the active biosorbent may be advantageous to support the growth and metabolism of a suitable microorganism, such as a bacteria belonging to the genus Bacillus.

In general, the bacterium in the genus Bacillus can be any suitable species, type, or sub-type. Examples of bacteria from the genus Bacillus include, but are not limited to, Bacillus alcalophilus, Bacillus alvei, Bacillus amyloliquefaciens, Bacillus aneurinolyticus, Bacillus anthracis, Bacillus aquaemaris, Bacillus atrophaeus, Bacillus boronophilus, Bacillus brevis, Bacillus caldolyyicus, Bacillus centrosporus, Bacillus cereus, Bacillus circulan, Bacillus coagulans, Bacillus firmus, Bacillus flavothermus, Bacillus fusiformis, Bacillus globigii, Bacillus infernus, Bacillus larvae, Bacillus laterosporus, Bacillus lentus, Bacillus licheniformis, Bacillus megaterium, Bacillus mesentericus, Bacillus mucilaginosus, Bacillus mycoides, Bacillus natto, Bacillus pantothenicus, Bacillus papilliae, Bacillus polymyxa, Bacillus pseudoanthracis, Bacillus pumilus, Bacillus schlegelii, Bacillus simplex, Bacillus sphaericus, Bacillus sporothermodurans, Bacillus stearothermophilus, Bacillus subtilis, Bacillusthermoglucosidasius, Bacillus thuringiensis, Bacillus vulgatis, Bacillus weihenstephanensis, Bacillus macerans, Bacillus butanolivorans, and/or mixtures thereof. In some embodiments, the bacterium is Bacillus subtilis. In some embodiments, mutants/variants of Bacillus subtilis may also be used.

In some embodiments, the bacterium in the genus Bacillus may have an average particle size in the range of 0.1 to 10 μm, preferably 0.2 to 5 μm, preferably 0.3 to 1 μm. For example, bacterium in the genus Bacillus may have an average particle size of about 0.4 μm, 0.5 μm, 0.6 μm, 0.7 μm, 0.8 μm, 0.9 μm, 1 μm, and all ranges in between.

In some embodiments, the active biosorbent has a weight ratio of the support to the bacterium of 1:1 to 100:1. For example, the weight ratio may be 1:1, 1.25:1, 1.5:1, 1.75:1, 2:1, 2.5:1, 3:1, 3.5:1, 4:1, 4.5:1, 5:1, 5.5:1, 6:1, 6.5:1, 7:1, 7.5:1, 8:1, 8.5:1, 9:1, 9.5:1, 10:1, 11:1, 12:1, 13:1, 14:1, 15:1, 16:1, 17:1, 18:1, 19:1, 20:1, 21:1, 22:1, 23:1, 24:1, 25:1, 26:1, 27:1, 28:1, 29:1, 30:1, 32.5:1, 35:1, 37.5:1, 40:1, 42.5:1, 45:1, 47.5:1, 50:1, 60:1, 70:1, 80:1, 90:1, or 100:1.

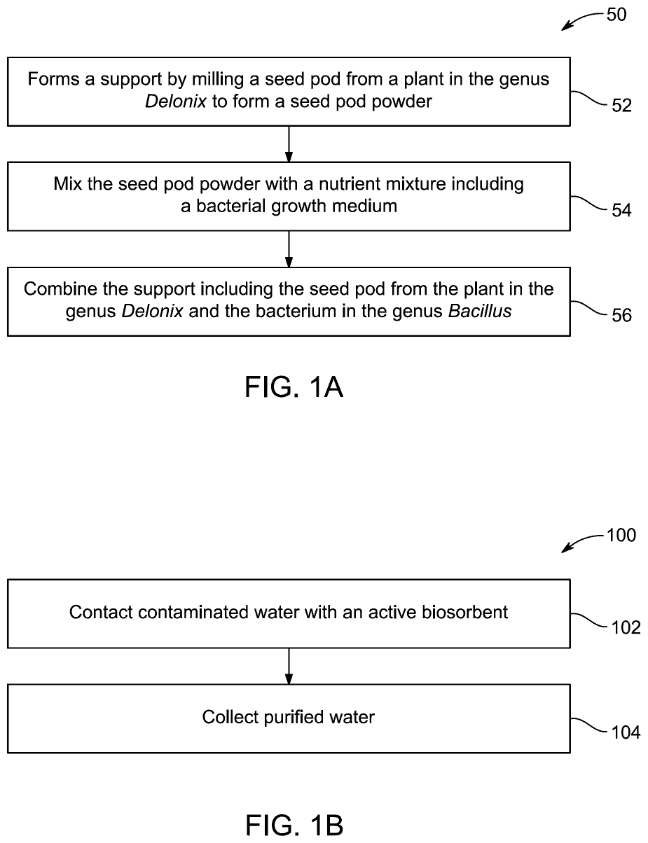

The present disclosure also relates to a method of forming the active biosorbent. Referring to FIG. 1A, an exemplary method 50 of preparing the active biosorbent is described. The order in which the method 50 is described is not intended to be construed as a limitation, and any number of the described method steps can be combined to implement the method 50. Additionally, individual steps may be removed or skipped from the method 50 without departing from the spirit and scope of the present disclosure.

At step 52, the method 50 includes forming the support by milling the seed pod from a plant in the genus Delonix to form a seed pod powder. In some embodiments, the seed pod from a plant in the genus Delonix is a Delonix regia seed pod. In some embodiments, the seed pod dried prior to milling. In general, the drying can be performed by any suitable technique. For example, the seed pod may be dried under sun light or in an oven for 12-36 hours. In some embodiments, the drying produces a dried seed pod having a moisture content of less than 20%, preferably less than 17.5%, preferably less than 15%, preferably less than 12.5%, preferably 10%. The pods can be ground to a fine powder via milling or grinding as described above to obtain the seed pod powder.

In some embodiments, the seed pods are treated to remove various components. Preferably, the treating does not remove cellulose, hemicellulose, or lignin. Examples of components that can be removed include, but are not limited to, saponins, flavonoids, terpenes, cardenolides, steroids, glycosides, and tannins, as described above. In general, the treatment can be performed before or after the milling and before or after the drying. In some embodiments, the treating involves treatment with a solvent, such as water or an organic solvent.

At step 54, the method 50 includes mixing the seed pod powder with a nutrient mixture including a bacterial growth medium. Mixing the seed pod powder with the nutrient mixture including the bacterial growth medium may be advantageous for providing essential nutrients like nitrogen, phosphorus, and trace minerals that support the growth and metabolism of the bacterium in the genus Bacillus, as described above.

At step 56, the method 50 includes combining the support including the seed pod from the plant in the genus Delonix and the bacterium in the genus Bacillus. In some embodiments, the method of combining the support with the bacterium may be mixing the support with a pellet of the bacterium in the genus Bacillus. In some other embodiments, the method of combining the support with the bacterium can be performed via inoculating the support with an inoculation solution including the bacterium in the genus Bacillus. In some embodiments, the inoculation solution including the Bacillus subtilis is inoculated into the support at a pH of 5 to 10, preferably 6 to 9, preferably 6.5 to 7.5 at a temperature of 30° C. to 37° C. The inoculating can be performed by combining the inoculation solution with the support, and may optionally include stirring or shaking shaking, for example at 120 rpm. Such stirring or shaking may be advantageous for ensuring proper aeration and mixing.

In some embodiments, after the combining, the active biosorbent is dried. This drying may be advantageous so that bacteria can adhere firmly to the support, creating a stable inoculum. Drying may also help preserve the viability of the bacteria, allowing them to remain active when reintroduced into suitable environment. In general, any suitable drying method(s) may be employed, such as air drying, oven drying, freeze-drying (lyophilization), vacuum drying or spray drying. In some embodiments, the drying is performed at 40° C., 60° C., or 80° C.

The present disclosure also relates to a method of removing an organic pollutant from water using the active biosorbent. Referring to FIG. 1B, an exemplary method 100 of removing an organic pollutant from water using the active biosorbent is described. In some embodiments, the organic pollutant is at least one selected from dye, a phenol, a polycyclic aromatic hydrocarbon, an herbicide, a pesticide, a persistent organic pollutant, and a biodiesel.

A dye is a colored substance that chemically binds to a material it may be intended to color. Generally, a dye is applied in solution, typically aqueous solution. Examples of dyes include, but are not limited to: acridine dyes, which are acridine and its derivatives such as acridine orange, acridine yellow, acriflavine, and gelgreen; anthraquinone dyes, which are anthroaquinone and its derivatives such as acid blue 25, alizarin, anthrapurpurin, carminic acid, 1,4-diamno-2,3-dihydroanthraquinone, 7,14-dibenzypyrenequinone, dibromoanthrone, 1,3-dihydroxyanthraquinone, 1,4-dihydroxyanthraquinone, disperse red 9, disperse red 11, indanthrone blue, morindone, oil blue 35, parietin, quinizarine green SS, remazol brilliant blue R, solvent violet 13, 1,2,4-trihydroxyanthraquinone, vat orange 1, and vat yellow 1; diaryl methane dyes such as auramine O, triarylmethane dyes such as acid fuchsin, aluminon, aniline blue WS, aurin, aurintricarboxylic acid, brilliant blue FCF, brilliant green, bromocresol green, bromocresol purple, bromocresol blue, bromophenol blue, bromopyrogallol red, chlorophenol red, coomassie brilliant blue, cresol red, O-cresolphthalein, crystal violet, dichlorofluorescein, ethyl green, fast green FCT, FIASH-EDT2, fluoran, fuchsine, green S, light green SF, malachite green, merbromin, metacresol purple, methyl blue, methyl violet, naphtholphthalein, new fuchsine, pararosaniline, patent blue V, phenol red, phenolphthalein, phthalein dye, pittacal, spirit blue, thymol blue, thymolphthalein, Victoria blue BO, Victoria blue R, water blue, xylene cyanol, and xylenol orange; azo dyes such as acid orange 5, acid red 13, alican yellow, alizarine yellow R, allura red AC, amaranth, amido black 10B, aniline yellow, arylide yellow, azo violet, azorubine, basic red 18, biebrich scarlet, Bismarck brown Y, black 7984, brilliant black BN, brown FK, chrysoine resorcinol, citrus red 2, congo red, D&C red 33, direct blue 1, disperse orange 1, eriochrome black T, evans blue, fast yellow AB, orange 1, hydroxynaphthol blue, janus green B, lithol rubine BK, metanil yellow, methyl orange, methyl red, methyl yellow, mordant brown 33, mordant red 19, naphthol AS, oil red O, oil yellow DE, orange B, orange G, orange GGN, para red, pigment yellow 10, ponceau 2R, prontosil, red 2G, scarlet GN, Sirius red, solvent red 26, solvent yellow 124, sudan black B, sudan I, sudan red 7B, sudan stain, tartrazine, tropaeolin, trypan blue, and yellow 2G; phthalocyanine dyes such as phthalocyanine blue BN, phthalocyanine Green G, Alcian blue, and naphthalocyanine, azin dyes such as basic black 2, mauveine, neutral red, Perkin's mauve, phenazine, and safranin; indophenol dyes such as indophenol and dichlorophenolindophenol; oxazin dyes; oxazone dyes; thiazine dyes such as azure A, methylene blue, methylene green, new methylene blue, and toluidine blue; thiazole dyes such as primuline, stains-all, and thioflavin; xanthene dyes such as 6-carboxyfluorescein, eosin B, eosin Y, erythosine, fluorescein, rhodamine B, rose bengal, and Texas red; fluorone dyes such as calcein, carboxyfluorescein diacetate succinimidyl ester, fluo-3, fluo-4, indian yellow, merbromin, pacific blue, phloxine, and seminaphtharhodafluor; or rhodamine dyes such as rhodamine, rhodamine 6G, rhodamine 123, rhodamine B, sulforhodamine 101, and sulforhodamine B.

A phenol is a compound consisting of a hydroxyl group (—OH) bonded directly to an aromatic hydrocarbon group. Examples of phenols include, but are not limited to, phenol (the namesake of the group of compounds), bisphenols (including bisphenol A), butylated hydroxytoluene (BHT), 4-nonylphenol, orthophenyl phenol, picric acid, phenolphthalein and its derivatives mentioned above, xylenol, diethylstilbestrol, L-DOPA, propofol, butylated hydroxyanisole, 4-tert-butylcatechol, tert-butylhydroquinone, carvacrol, chloroxyleol, cresol (including M-, O-, and P-cresol), 2,6-di-tert-butylphenol, 2,4-dimethyl-6-tert-butylphenol, 2-ethyl-4,5-dimethylphenol, 4-ethylguaiacol, 3-ethylphenol, 4-ethylphenol, flexirubin, mesitol, 1-nonyl-4-phenol, thymol, 2,4,6-tri-tert-butylphenol, chlorophenol (including 2-, 3-, and 4-chlorophenol), dichlorophenol (including 2,4- and 2,6-dichlorophenol), bromophenol, dibromophenol (including 2,4-dibromophenol), nitrophenol, norstictic acid, oxybenzone, and paracetamol (also known as acetoaminophen).

A polycyclic aromatic hydrocarbon (PAH) is an aromatic hydrocarbon composed of multiple aromatic rings. Examples of polycyclic aromatic hydrocarbons include naphthalene, anthracene, phenanthrene, phenalene, tetracene, chrysene, triphenylene, pyrene, pentacene, benzo[a]pyrene, corannulene, benzo[g,h,i]perylene, coronene, ovalene, benzo[c]fluorine, acenaphthene, acenaphthylene, benz[a]anthracene, benzo[b]fluoranthene, benzo[j]fluoranthene, benzo[k]fluoranthene, benzo[e]pyrene, cyclopenta[c,d]pyrene, dibenz[a,h]anthracene, dibenzo[a,e]pyrene, dibenzo[a,h]pyrene, dibenzo[a,i]pyrene, dibenzo[a,1]pyrene, fluoranthene, fluorine, indeno[1,2,3-c,d]pyrene, 5-methylchrysene, naphthacene, pentaphene, picene, and biphenylene.

An herbicide (also known as “weedkiller”) is a substance that is toxic to plants and may kill, inhibit the growth of, or prevent the germination of plants. Herbicides are typically used to control the growth of or remove unwanted plants from an area of land, particularly in an agricultural context. Examples of herbicides include, but are not limited to, 2,4-D, aminopyralid, chlorsulfuron, clopyralid, dicamba, diuron, glyphosate, hexazinone, imazapic, imazapyr, methsulfuron methyl, picloram, sulfometuron methyl, triclopyr, fenoxaprop, fluazifop, quizalofop, clethodim, sethoxydim, chlorimuron, foramsulfuron, halosulfuron, nicosulfuron, primisulfuron, prosulfuron, rimsulfuron, thofensulfuron, tribenuron, imazamox, imazaquin, flumetsulam, cloransulam, thiencarbazone, fluoxpyr, diflufenzopyr, atrazine, simazine, metribuzin, bromoxynil, bentazon, linuron, glufosinate, clomazone, isoxaflutole, topramezone, mesotrione, tembotrione, acifluorfen, formesafen, lactofen, flumiclorac, flumioxazin, fulfentrazone, carfentrazone, fluthiacet-ethyl, falufenacil, paraquat, ethalfluralin, pendimethalin, trifluralin, butylate, EPTC, ecetochlor, alachlor, metolachlor, dimethenamid, flufenacet, and pyroxasulfone.

A pesticide is a substance meant to prevent, destroy, or control pests including, but not limited to algae, bacteria, fungi, plants, insects, mites, snails, rodents, and viruses.

A pesticide intended for use against algae is known as an algicide. Examples of algicides include benzalkonium chloride, bethoxazin, cybutryne, dichlone, dichlorophen, diuron, endothal, fentin, isoproturon, methabenthiazuron, nabam, oxyfluorfen, pentachlorophenyl laurate, quinoclamine, quinonamid, simazine, terbutryn, and tiodonium.

A pesticide intended for use against bacteria is known as a bactericide. Examples of bactericides include antibiotics such as: aminoglycosides such as amikacin, gentamicin, kanamycin, neomycin, netilmicin, tobramycin, paromomycin, streptomycin, and spectinomycin; ansamycins such as geldanamycin, herbimycin, and rifaximin; carbacephems such as loracarbef; carbapenems such as ertapenem, doripenem, imipenem, and meropenem; cephalosporins such as cefadroxil, cefazolin, cephradine, cephapirin, cephalothin, cephalexin, cefaclor, cefoxitin, cefotetan, cefamandole, cefmetazole, cefonicid, cefprozil, cefuroxime, cefixime, cefdinir, cefditoren, cefoperazone, cefotaxime, cefpodoxime, cefazidime, ceftibuten, ceftizoxime, moxalactam, ceftriaxone, cefepime, cefaroline fosamil, and ceftobiprole; glycopeptides such as teicoplanin, vancomycin, telavancin, dalbavancin, and oritavancin; lincosamides such as clindamycin and lincomycin; lipopeptides such as daptomycin; macrolides such as azithromycin, clarithromycin, erythromycin, roxithromycin, telithromycin, spiramycin, and fidoxamicin; monobactams such as aztreonam; nitrofurans such as furazolidone and nitrofurantoin; oxazolidinones such as linezolid, posizolid, radezolid, and torezolid; penicillins such as amoxicillin, ampicillin, azlocillin, dicloxacillin, flucloxacillin, mezlocillin, methicillin, nafcillin, oxacillin, penicillins (including penicillin G and V), piperacillin, temocillin, and ticarcillin; polypeptides such as bacitracin, colistin, and polymyxin B; quinolones such as ciproflaxacin, enoxacin, gatifloxacin, gemifloxacin, levofloxacin, lomefloxacin, moxifloxacin, nadifloxacin, nalidixic acid, norfloxacin, ofloxacin, trovafloxacin, gepafloxacin, sparfloxacin, and temafloxacin; sulfonamides such as mafenide, sulfacetamide, sulfadiazine, sulfadithoxine, sulfamethizole, sulfamethoxazole, sulfanilamide, sulfasalazine, sulfisoxazole, and sulfonamidochrysoidine; tetracyclines such as demeclocycline, doxycycline, metacycline, minocycline, oxytetracycline, and tetracycline.

A pesticide intended for use against fungi is known as a fungicide. Examples of fungicides include acibenzolar, acypetacs, aldimorph, anilazine, aureofungin, azaconazole, azithiram, azoxystrobin, benalaxyl, benodanil, benomyl, benquinox, benthiavalicarb, binapacryl, biphenyl, bitertanol, bixafen, blasticidin-S, boscalid, bromuconazole, captafol, captan, carbendazim, carboxin, carpropamid, chloroneb, chlorothalonil, chlozolinate, cyazofamid, cymoxanil, cyprodinil, dichlofluanid, diclocymet, dicloran, diethofencarb, difenoconazole, diflumetorim, dimethachlone, dimethomorph, diniconazole, dinocap, dodemorph, edifenphos, enoxastrobin, epoxiconazole, etaconazole, ethaboxam, ethirimol, etridiazole, famoxadone, fenamidone, fenarimol, fenbuconazole, fenfuram, fenhexamid, fenoxanil, fenpropidin, fenpropimorph, ferbam, fluazinam, fludioxonil, flumorph, fluopicolide, fluopyram, fluoroimide, fluoxastrobin, flusilazole, flutianil, flutolain, flopet, fthalide, furalaxyl, guazatine, hexaconazole, hymexazole, imazalil, imibenconazole, iminoctadine, iodocarb, ipconazole, iprobenfos, iprodione, iprovalicarb, siofetamid, isoprothiolane, isotianil, kasugamycin, laminarin, mancozeb, mandestrobin, mandipropamid, maneb, mepanypyrim, mepronil, meptyldinocap, mealaxyl, metominostrobin, metconazole, methafulfocarb, metiram, metrafenone, myclobutanil, naftifine, nuarimol, octhilinone, ofurace, orysastrobin, oxadixyl, oxathiapiprolin, oxolinic acid, oxpoconazole, oxycarboxin, oxytetracycline, pefurazate, penconazole, pencycuron, penflufen, penthiopyrad, phenamacril, picarbutrazox, picoxystrobin, piperalin, polyoxin, probenzole, prochloraz, procymidone, propamocarb, propiconazole, propineb, proquinazid, prothiocarb, prothioconazole, pydiflumetofen, pyraclostrobin, pyrametostrobin, pyraoxystrobin, pyrazophos, pyribencarb, pyributicarb, pyrifenox, pyrimethanil, pyrimorph, pyriofenone, pyroquilon, quinoxyfen, quintozene, sedaxane, silthiofam, simeconazole, spiroxamine, streptomycin, tebuconazole, tebufloquin, teclofthalam, tecnazene, terbinafine, tetraconazole, thiabendazole, thifluzamide, thiphanate, thiram, tiadinil, tolclosfos-methyl, folfenpyrid, tolprocarb, tolylfluanid, triadimefon, triadimenol, triazoxide, triclopyricarb, tricyclazole, tridemorph, trifloxystrobin, triflumizole, triforine, validamycin, and vinclozolin.

A pesticide intended for use against plants is known as an herbicide as described above. A pesticide intended for use against insects is known as an insecticide. Examples of insecticides are: organochlorides such as Aldrin, chlordane, chlordecone, DDT, dieldrin, endofulfan, endrin, heptachlor, hexachlorobenzene, lindane, methoxychlor, mirex, pentachlorophenol, and TDE; organophosphates such as acephate, azinphos-methyl, bensulide, chlorethoxyfos, chlorpyrifos, diazinon, chlorvos, dicrotophos, dimethoate, disulfoton, ethoprop, fenamiphos, fenitrothion, fenthion, malathion, methamdophos, methidathion, mevinphos, monocrotophos, naled, omethoate, oxydemeton-methyl, parathion, phorate, phosalone, phosmet, phostebupirim, phoxim, pirimiphos-methyl, profenofos, terbufos, and trichlorfon; carbamates such as aldicarb, bendiocarb, carbofuran, carbaryl, dioxacarb, fenobucarb, fenoxycarb, isoprocarb, methomyl; pyrethroids such as allethrin, bifenthrin, cyhalothrin, cypermethrin, cyfluthrin, deltamethrin, etofenprox, fenvalerate, permethrin, phenothrin, prallethrin, resmethrin, tetramethrin, tralomethrin, and transfluthrin; neonicotinoids such as acetamiprid, clothiandin, imidacloprid, nithiazine, thiacloprid, and thiamethoxam; ryanoids such as chlorantraniliprole, cyanthaniliprole, and flubendiamide.

A pesticide intended for use against mites is known as a miticide. Examples of miticides are permethrin, ivermectin, carbamate insecticides as described above, organophosphate insecticides as described above, dicofol, abamectin, chlorfenapyr, cypermethrin, etoxazole, hexythiazox, imidacloprid, propargite, and spirotetramat.

A pesticide intended for use against snails and other mollusks is known as a molluscicide. Examples of molluscicides are metaldehyde and methiocarb.

A pesticide intended for use against rodents is known as a rodenticide. Examples of rodenticides are warfarin, coumatetralyl, difenacoum, brodifacoum, flocoumafen, bromadiolone, diphacinone, chlorophacinone, pindone, difethialone, cholecalciferol, ergocalciferol, ANTU, chloralose, crimidine, 1,3-difluoro-2-propanol, endrin, fluroacetamide, phosacetim, pyrinuron, scilliroside, strychnine, tetramethylenedisulfotetramine, bromethalin, 2,4-dinitrophenol, and uragan D2.

A pesticide intended for use against viruses is known as a virucide. Examples of virucides are cyanovirin-N, griffithsin, interferon, NVC-422, scytovirin, urumin, virkon, zonroz, and V-bind viricie. A persistent pollutant is a toxic chemical that adversely affects human and environmental health, can be transported by wind and water, and can persist for years, decades, or centuries owing to resistance to environmental degradation by natural chemical, biological, or photolytic processes. Persistent pollutants are regulated by the United Nations Environment Programme 2001 Stockholm Convention on Persistent Pollutants. Examples of persistent pollutants are Aldrin, chlordane, dieldrin, endrin, heptachlor, hexachlorobenzene, mirex, toxaphene, polychlorinated biphenyl (PCBs), dichlorodiphenyltrichloroethane (DDT), dioxins, polychlorinated dibenzofurans, chlordecone, hexachlorocyclohexane (α- and β-), hexabromodiphenyl ether, lindane, pentachlorobenzene, tetrabromodiphenyl ether, perfluorooctanesulfonic acid, endosulfans, and hexabromocyclododecane.

In a preferred embodiment, the organic pollutant is a liquid fuel, for example, kerosene fuel, diesel fuel, gasoline fuel, biodiesel fuel, alcohol fuel, gasoline fuel and/or synthetic fuel. Alcohol fuels include, but are not limited to, methanol, ethanol, 1-propanol, isopropanol, n-butanol, iso-butanol, tert-butanol, n-pentanol, isoamyl alcohol, and mixtures thereof. Synthetic fuels include, but are not limited to, dimethyl ether (DME), fuel produced from processes such as Fischer-Tropsch conversion, methanol to gasoline conversion, or direct coal liquefaction. In one preferred embodiment, the liquid fuel is diesel fuel.

As used herein, the term “biodiesel” refers to a renewable, biodegradable fuel made from organic materials, primarily vegetable oils, animal fats, or recycled cooking oils. It is produced through a process called transesterification, where triglycerides react with an alcohol (usually methanol or ethanol) in the presence of a catalyst to form fatty acid esters, such as fatty acid methyl esters (FAME), and glycerol. Biodiesel can be used as a substitute for or blended with petroleum diesel in diesel engines, offering a cleaner-burning alternative that can reduce greenhouse gas emissions and dependence on fossil fuels.

The order in which the method 100 is described is not intended to be construed as a limitation, and any number of the described method steps can be combined to implement the method 100. Additionally, individual steps may be removed or skipped from the method 100 without departing from the spirit and scope of the present disclosure.

At step 102, the method 100 includes contacting a contaminated water with the active biosorbent. In some embodiments, the active biosorbent can be contacted with a nutrient solution including a bacterial growth medium, prior to contacting the active biosorbent with the contaminated water. Supplementing the active biosorbent with a nutrient solution containing a bacterial growth medium may be advantageous for enhancing microbial growth and activity. This enhanced activity may be associated with improved, faster, and/or more complete degradation of organic matter in the water treatment.

In general, the contacting of the contaminated water with the active biosorbent can be performed by any suitable technique and with any suitable equipment known to those in the art. In some embodiments, the contacting of the contaminated water with the active biosorbent is performed by flowing the contaminated water through a bed including the active biosorbent in a reactor. The reactor may be any suitable type of reactor and have any suitable geometry or features. For example, the reactor can be a fixed bed reactor, packed column, fluidized bed reactor, or the like. In some embodiments, contacting may be performed in a continuous manner. That is, the contaminated water is continuously flowed through the reactor containing the active biosorbent. In some embodiments, the contacting may be performed in a batch or discontinuous manner. That is, the contaminated water may be contacted with or exposed to the active biosorbent and allowed to remain in static contact for a period of time. In some embodiments, the method involve the use of multi-stage adsorption with the active biosorbent. For example, multiple fixed bed columns or reactors of the active biosorbent or, more broadly, multiple adsorption units of any suitable modes or configurations and their combinations, e.g. batch adsorption, cartridge, fluidized bed reactor, etc., can be set up to remove the organic pollutant from the contaminated water in a parallel and/or sequential manner.

In some embodiments, the contacting can be performed using a column containing the active biosorbent. In some embodiments, the column is a packed column. A packed column can include the active biosorbent contained within a container and packed at an appropriate packing density to both ensure adequate contact between the active biosorbent and the contaminated water and to permit the contaminated water to flow through the packed active biosorbent. In some embodiments, the active biosorbent is packed into the column with a packing density of 0.10 to 2.5 g/cm³. For example, the packing density may be 0.10 g/cm³, 0.15 g/cm³, 0.20 g/cm³, 0.25 g/cm³, 0.30 g/cm³, 0.35 g/cm³, 0.40 g/cm³, 0.45 g/cm³, 0.50 g/cm³, 0.55 g/cm³, 0.60 g/cm³, 0.65 g/cm³, 0.70 g/cm³, 0.75 g/cm³, 0.80 g/cm³, 0.85 g/cm³, 0.90 g/cm³, 0.95 g/cm³, 1.00 g/cm³, 1.05 g/cm³, 1.10 g/cm³, 1.15 g/cm³, 1.20 g/cm³, 1.25 g/cm³, 1.30 g/cm³, 1.35 g/cm³, 1.40 g/cm³, 1.45 g/cm³, 1.50 g/cm³, 1.55 g/cm³, 1.60 g/cm³, 1.65 g/cm³, 1.70 g/cm³, 1.75 g/cm³, 1.80 g/cm³, 1.85 g/cm³, 1.90 g/cm³, 1.95 g/cm³, 2.00 g/cm³, 2.05 g/cm³, 2.10 g/cm³, 2.15 g/cm³, 2.20 g/cm³, 2.25 g/cm³, 2.30 g/cm³, 2.35 g/cm³, 2.40 g/cm³, 2.45 g/cm³, or 2.50 g/cm³.

In general, the column can have any suitable shape. In general, the shape can have any suitable cross-sectional shape, such as circular, elliptical, polygonal, and the like. In some embodiments, the column has a circular cross-sectional shape. The circular cross-sectional shape may be advantageous for withstanding the pressure of the contaminated water or an applied pressure. In some embodiments, the column is substantially cylindrical. The cylindrical shape can have straight walls (e.g., a constant diameter) or have tapered walls (e.g., a non-constant diameter) along its length. In some embodiments, the column is a cylindrical shape having a diameter of 0.5 to 50 cm. For example, the diameter may be 0.5 cm, 0.75 cm, 1.0 cm, 1.25 cm, 1.50 cm, 1.75 cm, 2.0 cm, 2.25 cm, 2.5 cm, 2.75 cm, 3.0 cm, 3.25 cm, 3.5 cm, 3.75 cm, 4.0 cm, 4.25 cm, 4.5 cm, 4.75 cm, 5.0 cm, 5.5 cm, 6.5 cm, 7.0 cm, 7.5 cm, 8.0 cm, 8.5 cm, 9.0 cm, 9.5 cm, 10.0 cm, 10.5 cm, 11.0 cm, 11.5 cm, 12.0 cm, 12.5 cm, 15 cm, 20 cm, 25 cm, 30 cm, 35 cm, 40 cm, 45 cm, or 50 cm. In some embodiments the column is a cylindrical shape having a length of 5 to 250 cm. For example, the length can be 5 cm, 7.5 cm, 10 cm, 12.5 cm, 15 cm, 17.5 cm, 20 cm, 22.5 cm, 25 cm, 27.5 cm, 30 cm, 35 cm, 40 cm, 45 cm, 50 cm, 55 cm, 60 cm, 65 cm, 70 cm, 75 cm, 80 cm, 85 cm, 90 cm, 95 cm, 100 cm, 110 cm, 120 cm, 130 cm, 140 cm, 150 cm, 160 cm, 170 cm, 180 cm, 190 cm, 200 cm, 210 cm, 220 cm, 230 cm, 240 cm, or 250 cm. In some embodiments, the column has an aspect ratio of 0.1 to 500. For example, the aspect ratio can be 0.1, 0.25, 0.5, 0.75, 1, 1.5, 2, 2.5, 3, 3.5, 4, 4.5, 5, 5.5, 6, 6.5, 7, 7.5, 8, 8.5, 9, 9.5, 10, 11, 12, 13, 14, 15, 16, 17, 18, 19, 20, 22.5, 25, 27.5, 30, 32.5, 35, 37.5, 40, 42.5, 45, 47.5, 50, 60, 70, 80, 90, 100, 125, 150, 200, or 250.

In some embodiments, the active biosorbent is present in 2.5 to 95% of an interior volume of the column. For example, the active biosorbent can be present in 2.5%, 3.0%, 3.5%, 4.0%, 4.5%, 5.0%, 5.5%, 6.0%, 6.5%, 7.0%, 7.5%, 8.0%, 8.5%, 9.0%, 9.5%, 10%, 11%, 12%, 13%, 14%, 15%, 16%, 17%, 18%, 19%, 20%, 22.5%, 25%, 27.5%, 30%, 32.5%, 35%, 37.5%, 40%, 42.5%, 45%, 47.5%, 50%, 52.5%, 55%, 57.5%, 60%, 62.5%, 65%, 67.5%, 70%, 72.5%, 75%, 77.5%, 80%, 82.5%, 85%, 87.5%, 90%, 92.5%, or 95% of the interior volume of the column. The remaining interior volume of the column can be occupied by other suitable materials such as stoppers, plugs or internal supports to hold the active biosorbent in place, other sorbents such as ion exchange resins or metal absorbing resins or sorbents, polymer beads such as polystyrene beads, glass beads, sand, glass wool, and the like. Such plugs or stoppers should be porous to permit the water to pass into the column.

In some embodiments, the reactor/the bed includes the active biosorbent up to at least 30%, preferably 40%, preferably 50%, preferably 60% of its total capacity. In some embodiments, the contaminated water is passed/flowed into a bed/reactor at a flowrate of 10 mL/min to 20 mL/min. For example, the water may be flowed with a flowrate of 10 mL/min, 10.5 mL/min, 11 mL/min, 11.5. mL/min, 12 mL/min, 12.5 mL/min, 13 mL/min, 13.5 mL/min, 14 mL/min, 14.5 mL/min, 15 mL/min, 15.5 mL/min, 16 mL/min, 16.5 mL/min, 17 mL/min, 17.5 mL/min, 18 mL/min, 18.5 mL/min, 19 mL/min, 19.5 mL/min, or 20 mL/min. In some embodiments, the bed, including the active biosorbent, has a length of 2.5 cm to 25 cm, preferably 5 to 20 cm, and a diameter of 1 cm to 5 cm, preferably 2 to 4 cm, preferably about 2.5 cm.

In some embodiments, the contaminated water is contacted with the active biosorbent at a temperature of about 4 to 100° C. For example, the contaminated water can be contacted with the active biosorbent at a temperature of about 4° C., 5° C., 10° C., 15° C., 20° C., 25° C., 30° C., 35° C., 40° C., 45° C., 50° C., 55° C., 60° C., 65° C., 70° C., 75° C., 80° C., 85° C., 90° C., 95° C., or 100° C.

In some embodiments, the contaminated water is contacted with the active biosorbent at a pressure of about 1 to 100 bar. For example, the contaminated water can be contacted with the active biosorbent at a pressure of about 1 bar, 1.5 bar, 2 bar, 2.5 bar, 3 bar, 3.5 bar, 4 bar, 4.5 bar, bar, 5.5 bar, 6 bar, 6.5 bar, 7 bar, 7.5 bar, 8 bar, 8.5 bar, 9 bar, 9.5 bar, 10 bar, 11 bar, 12 bar, 13 bar, 14 bar, 15 bar, 16 bar, 17 bar, 18 bar, 19 bar, 20 bar, 25 bar, 30 bar, 35 bar, 40 bar, 45 bar, 50 bar, 55 bar, 60 bar, 65 bar, 70 bar, 75 bar, 80 bar, 85 bar, 90 bar, 95 bar, or 100 bar.

In some embodiments, the contaminated water is contacted with the active biosorbent under aerobic conditions. In some embodiments, the contaminated water is contacted with the active biosorbent under anaerobic conditions.

In some embodiments, the contacting of the active biosorbent with contaminated water, results in removal of at least a portion of the organic pollutant in the contaminated water. In general, such removal can be the result of interaction between the organic pollutant and the active biosorbent. In general, the nature of interaction between the organic pollutant and the active biosorbent can be via a physical interaction, such as adsorption or a chemical interaction such as ionic, Van der Waals, hydrogen bonding, etc. Following the contacting, the active biosorbent with the contaminated pollutant may be referred to as a contaminated active biosorbent. The removal may also be the result of a biodegradation process performed by the bacteria. That is, the bacteria may, using biological and/or chemical processes, degrade the organic pollutant into any number of suitable biodegradation products. Such biodegradation products can become adsorbed by the active biosorbent.

In some embodiments, the active biosorbent has an adsorption capacity of 10 mg biodiesel/g to 300 mg biodiesel/g, preferably 85 mg biodiesel/g to 250 mg biodiesel/g, preferably about 75 mg biodiesel/g to 200 mg biodiesel/g of the active biosorbent. For example, the active biosorbent may have an adsorption capacity of 10 mg biodiesel/g, 15 mg biodiesel/g, 20 mg biodiesel/g, 25 mg biodiesel/g, 30 mg biodiesel/g, 35 mg biodiesel/g, 40 mg biodiesel/g, 45 mg biodiesel/g, 50 mg biodiesel/g, 55 mg biodiesel/g, 60 mg biodiesel/g, 65 mg biodiesel/g, 70 mg biodiesel/g, 75 mg biodiesel/g, 80 mg biodiesel/g, 85 mg biodiesel/g, 90 mg biodiesel/g, 95 mg biodiesel/g, 100 mg biodiesel/g, 105 mg biodiesel/g, 110 mg biodiesel/g, 115 mg biodiesel/g, 120 mg biodiesel/g, 125 mg biodiesel/g, 130 mg biodiesel/g, 135 mg biodiesel/g, 140 mg biodiesel/g, 145 mg biodiesel/g, 150 mg biodiesel/g, 155 mg biodiesel/g, 160 mg biodiesel/g, 165 mg biodiesel/g, 170 mg biodiesel/g, 175 mg biodiesel/g, 180 mg biodiesel/g, 185 mg biodiesel/g, 190 mg biodiesel/g, 195 mg biodiesel/g, 200 mg biodiesel/g, 205 mg biodiesel/g, 210 mg biodiesel/g, 215 mg biodiesel/g, 220 mg biodiesel/g, 225 mg biodiesel/g, 230 mg biodiesel/g, 235 mg biodiesel/g, 240 mg biodiesel/g, 245 mg biodiesel/g, 250 mg biodiesel/g, 255 mg biodiesel/g, 260 mg biodiesel/g, 265 mg biodiesel/g, 270 mg biodiesel/g, 275 mg biodiesel/g, 280 mg biodiesel/g, 285 mg biodiesel/g, 290 mg biodiesel/g, 295 mg biodiesel/g, or 200 mg biodiesel/g. In some embodiments, the active biosorbent has an adsorption capacity of 80 mg biodiesel/g to 159 mg biodiesel/g of the active biosorbent.

In some embodiments, the active biosorbent has an organic pollutant removal efficiency of 85% to 99%, preferably 87% to 98%, and more preferably 89% to 96%, based on an initial amount of organic pollutant present in the contaminated water. In some embodiments, the method has a removal efficiency of 90% to 99% based on an initial amount of organic pollutant present in the contaminated water.

In some embodiments, the removal of the organic pollutant by the active biosorbent includes adsorption. In general, the nature of interaction between the organic pollutant and the active biosorbent can be via a physical interaction, such as adsorption or a chemical interaction such as ionic, Van der Waals, hydrogen bonding, etc. Following the contacting, the active biosorbent with the contaminated pollutant may be referred to as a contaminated active biosorbent. In some embodiments, the removal of the organic pollutant by the active biosorbent includes biodegradation. That is, the removal may be or may also be the result of a biodegradation process performed by the bacteria. The bacteria may, using biological and/or chemical processes, degrade the organic pollutant into any number of suitable biodegradation products. Such biodegradation products can become adsorbed by the active biosorbent.

At step 104, the method 100 includes collecting a purified water. The purified water has, in general, a lower amount of the organic pollutant than polluted water. In some embodiments, the method has a removal efficiency of 90 to 99% based on an initial amount of organic pollutant present in the contaminated water. For example, the method can remove 90%, 90.5%, 91%, 91.5%, 92%, 92.5%, 93%, 93.5%, 94%, 94.5%, 95%, 95.5%, 96%, 96.5%, 97%, 97.25%, 97.5%, 97.75%, 98%, 98.25%, 98.5%, 98.75%, 99%, 99.25%, 99.5%, 99.75%, or 99.9% of the organic pollutant present in the contaminated water. In some embodiments, the purified water is substantially free of the organic pollutant. In some embodiments, the purified water is devoid of the organic pollutant.

In some embodiments, the method includes regenerating the active biosorbent. The regeneration can be performed by methods known in the art. In a preferred embodiment, the regeneration of the active biosorbent is carried out by eluting from the contaminated active biosorbent, using an elution solution, at least one selected from the group consisting of the organic pollutant and a biodegradation product of the organic pollutant. In general, the elution solution can include water and/or an organic solvent. Examples of organic solvents include, but are not limited to, alcohols such as methanol, ethanol, n-propanol, 2-propanol (also known as isopropanol), ethylene glycol, diethylene glycol, and glycerol; hydrocarbons such as pentane, hexane, and heptane; ketones such as acetone and methyl ethyl ketone; esters such as ethyl acetate; amides such as dimethylformamide; ethers such as tetrahydrofuran, diglyme, and diethyl ether; nitriles such as acetonitrile; halogenated organic solvents such as methylene chloride (also known as dichloromethane), carbon tetrachloride, and chloroform; aromatic organic solvents such as benzene and xylene; amines such as trimethylamine and pyridine; and mixtures thereof. The process of elution may be performed so as to remove organic pollutants or biodegradation products from the active biosorbent for further use, such as in a fertilizer.

### EXAMPLES

The following examples demonstrate an active biosorbent as described herein. The examples are provided solely for illustration and are not to be construed as limitations of the present disclosure, as many variations thereof are possible without departing from the spirit and scope of the present disclosure.

### Example 1: Design of Continuous Column

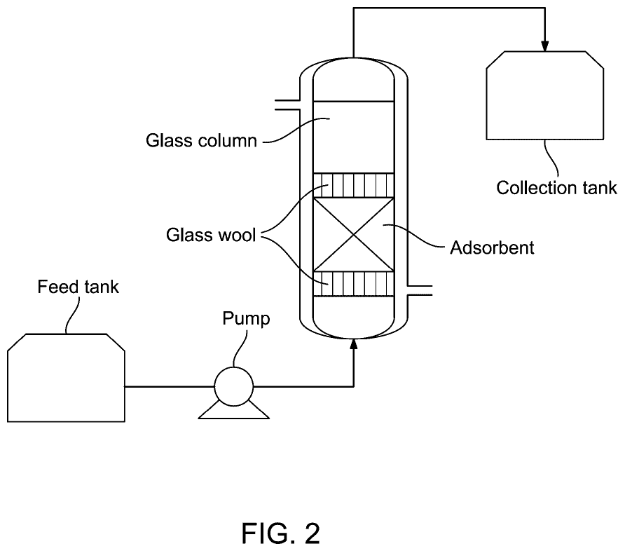

The design of the continuous column was done based on the flow rate and capacity of the adsorbent. FIG. 2 illustrates a design for an exemplary continuous column. The exemplary continuous column included a feed tank, a peristaltic pump, a glass column, an adsorbent, a glass wool, and a collection tank. The design parameters included capacity of the column, the capacity of the adsorbent, the flow rate, and the bed height of the column. The column height was selected to be 50 centimeters (cm), and the bed diameter was selected to be 2.5 cm. The material of construction was glass. The peristaltic pump is used to pump the fluid from the collection tank. The collection tank had a capacity of 15 liters, for the influent. The collection tank waws disposed near the glass column and a first end of a conduit from the peristaltic pump was fluidly coupled with the collection tank. Further, a second end of the conduit was connected to the glass column at a top end of the glass column. Mesh and the glass wool were used at a bottom end of the glass column to prevent the leakage of the adsorbent from the bottom end. The flow was from the bottom end of the glass column towards the top end of the glass column, in order for desirable contact between the adsorbent and an adsorbate. The overflow liquid was collected in the collection tank.

### Example 2: Material and Operating Process of Column

A packed column was designed with a diameter of 2.5 cm and the height of 50 cm. The bottom end and top end of the column were packed with glass wool to prevent loss of adsorbent. The concentration of biodiesel wastewater was kept constant which was 100 milligram per liter (mg/l). Constant pumping of the biodiesel wastewater solution was done using a peristaltic pump that was connected to a feed tank. pH of the solution was kept 7 as it was the optimized value in the batch experiments which provided maximum reduction in chemical oxygen demand (COD).

A constant check was done to ascertain that a constant equal volume of biodiesel wastewater was passed to the column. The required flow rate of the biodiesel wastewater solution was maintained by the peristaltic pump. Initially, the column was cleaned thoroughly with distilled water. The accurate weight of the adsorbent was measured and recorded. Further, the column was packed by the adsorbent. A rubber tube was used to remove the air bubbles present in the column, since removal of air from the column is vital for desired output from the column. Parameters like flow rate and bed height were varied for a plurality of experimental readings. The total weight of the adsorbent was varied for column experiments. The constant head was maintained for the column operation.

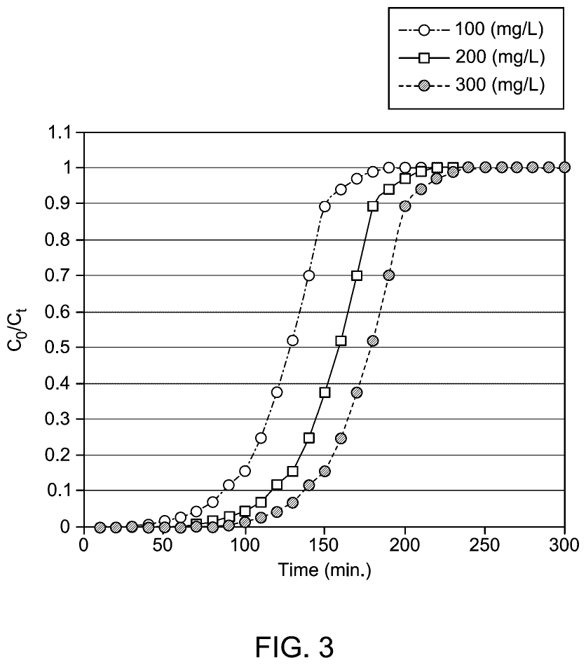

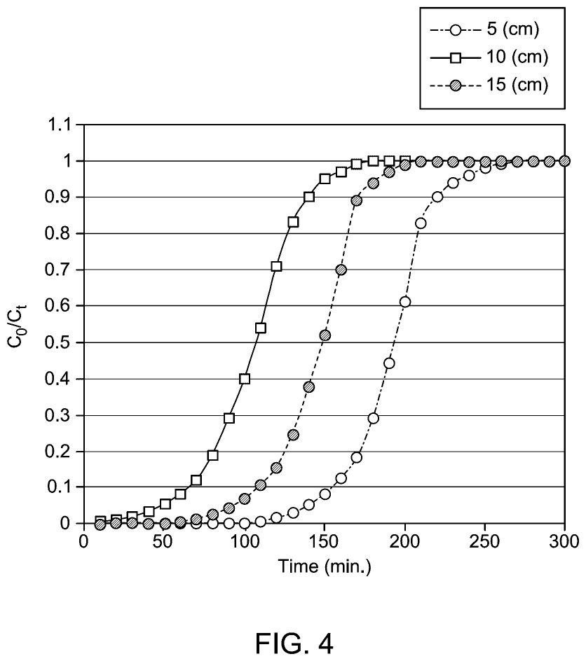

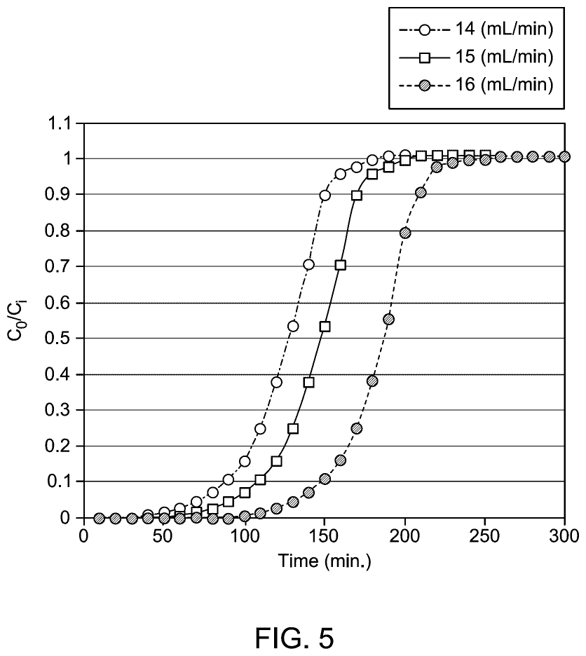

Inlet concentrations were varied for the experiments, as shown in FIG. 3. Bed height was varied from 5 cm, 10 cm, 15 cm, as shown in FIG. 4. For each height, the flow rate was varied correspondingly. The flow rate of the biodiesel wastewater solution was kept at 14 ml/min, 15 ml/min, and 16 ml/min for three different bed heights, as shown in FIG. 5. At fixed intervals of time, biodiesel wastewater samples were collected and checked for biodiesel wastewater COD. Till equilibrium time, experiments were conducted. The column configuration may be advantageous in that every second the new solution is in contact with the adsorbent so that maximum biodiesel wastewater may be adsorbed.

Bacillus was the microorganism chosen for use in the biosorbent used for the treatment of biodiesel wastewater. Biofertilizer for the Bacillus bacteria was added to the carrier. The bacteria present in biosorbent may be responsible for the removal of treatment of biodiesel wastewater, which may be biodegraded to achieve removal from the wastewater. The mechanism of treatment of biodiesel wastewater may include adsorption and/or degradation. Complete removal of the treatment of biodiesel wastewater was observed in the column for continuous column experiments.

### Example 3: Characterization and Results

The Bacillus subtilis were inoculated in the minimal medium for growth, under neutral conditions which are favored by Bacillus microorganisms. The culture was grown for 24 hours to 48 hours at 30° C. for Bacillus and at 37° C. in an incubator shaker at 120 revolutions per minute (rpm). After the growth reached an optical density of 0.8 to 1 at 600 nanometers (nm), and the cells were harvested by centrifugation at 8000 rpm for 20 minutes at 4° C. The supernatant was found to contain the extracellular enzyme and cell pellets were treated further if the intracellular enzyme was found to be present inside the cells. The characteristics of Bacillus are shown in Table 1.

TABLE 1
Characteristics of Bacillus

| Name of | | Zeta potential pH | | |
|---|---|---|---|---|
| microorganismes | Color | (5.7-7) | Shape | Size (μm) |
| Bacillus subtilis | Creamish | −18.67 | Oval | 0.65997 |
| | yellow | | | |

The effect of various adsorption parameters on the efficiency of the treatment of biodiesel wastewater was explored by univariate analysis, and the results and observations are presented in Table 2 and Table 3. Under the identified advantageous conditions, a removal efficiency of more than 98% was achieved with a single adsorption approach. The percentage removal of organic pollutant present in the contaminated water using a single adsorption approach is presented in Table 4.

TABLE 2
Size (DLS) analyses for Bacillus.

| | | | Effluent | | |
|---|---|---|---|---|---|
| | Start | | Diameter | Polydis- | Baseline |
| Type | Date/Time | Sample ID | (nm) | persity | Index |
| DLS | 19-05-2023 15:38 | BACILLUS-1 | 459.29 | 0.313 | 0 |
| DLS | 19-05-2023 15:40 | BACILLUS-2 | 703.14 | 0.033 | 7.5 |
| DLS | 19-05-2023 15:42 | BACILLUS-3 | 817.47 | 0.421 | 0.5 |
| | | Mean | 659.97 | 0.256 | 2.5 |
| | | Std Err: | 105.63 | 0.116 | 2.5 |
| | | Std Dev: | 182.95 | 0.2 | 4.3 |

TABLE 3
Zeta potential analyses (PALS) for Bacillus.

| | | | Zeta | | |
|---|---|---|---|---|---|
| | | | Potential | Mobility | |
| Type | Start Date/Time | Sample ID | (mV) | (μ/s)(V/cm) | RMS Residual |
| PALS | 19-05-2023 15:49 | BACILLUS-1 | −16.69 | −1.3 | 4.00E−02 |
| PALS | 19-05-2023 15:50 | BACILLUS-2 | −26.11 | −2.04 | 2.90E−02 |
| PALS | 19-05-2023 15:50 | BACILLUS-3 | −13.21 | −1.03 | 4.05E−02 |
| | | Mean | −18.67 | −1.46 | 3.63E−02 |
| | | Std Err: | 3.85 | 0.3 | 3.97E−03 |
| | | Std Dev: | 6.67 | 0.52 | 6.87E−03 |

TABLE 4
Single adsorption approach to show the percentage removal of organic pollutant present
in the contaminated water.

| | Size of | Bed | | | | |
|---|---|---|---|---|---|---|
| | Column | dimensions | | Quantity | | |
| | (height, | (height, | Flow | of | Adsorption | Removal |
| | diameter) | diameter) | rate | Adsorbent | capacity | Efficiency |
| Set | cm | cm | (ml/min) | used (gm) | (mg/gm) | (%) |
| Column | 50, 2.5 | 5, 2.5 | 14 | 20 | 89 | 93 |
| Column | 50, 2.5 | 10, 2.5 | 15 | 25 | 111 | 95 |
| Column | 50, 2.5 | 15, 2.5 | 16 | 30 | 158 | 98 |

The sorbent including physically modified Delonix regia pods powder in combination with Bacillus subtilis was found to be an effective biosorbent for biodiesel wastewater. This sorbent may be advantageous for achieving efficient separation and/or remediation of biodiesel contamination and/or for being cost-effective. The bioadsorbents in columns showed improved performance by obtaining higher removal efficiency in a shorter time. Treatment of biodiesel wastewater was 1.6 times more effective and achieved in a shorter time. Further, the use of biosorbent may be environmentally acceptable as it may have advantages in disposal of spent biosorbent. The biosorbent may also be used as fertilizer.

Numerous modifications and variations of the present disclosure are possible in light of the above teachings. It is therefore to be understood that within the scope of the appended claims, the invention may be practiced otherwise than as specifically described herein.

1. An active biosorbent cartridge, comprising
an active biosorbent comprising
a support comprising a seed pod from a plant in the genus Delonix in powder form; and
a bacterium in the genus Bacillus disposed on the support; and
a container in which the active biosorbent is disposed comprising a porous plug configured to contain the active biosorbent in the container, wherein
the active biosorbent has a weight ratio of the support to the bacterium of 1:1 to 25:1.

2. The active biosorbent cartridge of claim 1, wherein
the plant in the genus Delonix is Delonix regia.

3. The active biosorbent cartridge of claim 1, wherein
the seed pod from a plant in the genus Delonix is in the form of a ground powder.

4. The active biosorbent cartridge of claim 1, wherein
the seed pod from a plant in the genus Delonix includes
to 45 wt. % cellulose;
to 45 wt. % hemicellulose; and
to 25 wt. % lignin, each based on a total weight of seed pod from a plant in the genus Delonix.

5. The active biosorbent cartridge of claim 1, wherein
the bacterium in the genus Bacillus is Bacillus subtilis.

6. The active biosorbent cartridge of claim 1, wherein
the active biosorbent has an adsorption capacity of 75 to 200 mg biodiesel/g.

7. The active biosorbent cartridge of claim 1, wherein
the support further comprises a nutrient mixture comprising a bacterial growth medium.

8. A method of removing an organic pollutant from water, the method comprising
contacting a contaminated water with the active biosorbent cartridge of claim 1, and
collecting a purified water,
wherein the organic pollutant is at least one selected from the group consisting of a dye, a phenol, a polycyclic aromatic hydrocarbon, an herbicide, a pesticide, a persistent organic pollutant, and a biodiesel.

9. The method of claim 8, wherein
the organic pollutant is a biodiesel.

10. The method of claim 8, wherein
the plant in the genus Delonix is Deonix regia.

11. The method of claim 8, wherein the bacterium is in the genus Bacillus is Bacillus subtilis.

12. The method of claim 8, wherein the active biosorbent has an adsorption capacity of 75 to 200 mg biodiesel/g.

13. The method of claim 8, wherein
the contacting is performed by flowing the contaminated water through a bed comprising the active biosorbent at a flowrate of 10 to 20 mL/min, the bed comprising the active biosorbent having a length of 2.5 to 25 cm and a diameter of 1 to 5 cm.

14. The method of claim 8, wherein
the method has a removal efficiency of 90 to 99% based on an initial amount of organic pollutant present in the contaminated water.

15. The method of claim 8, further comprising
eluting, from the contaminated biosorbent using an elution solution, at least one selected from the group consisting of the organic pollutant and a biodegradation product of the organic pollutant.

16. The method of claim 8, further comprising
supplementing the active biosorbent by contacting the active biosorbent with a nutrient solution comprising a bacterial growth medium.

17. A method of forming the active biosorbent of claim 1, the method comprising
combining the support comprising a seed pod from a plant in the genus Delonix and the bacterium in the genus Bacillus.

18. The method of claim 17, further comprising
forming the support by milling the seed pod from a plant in the genus Delonix to form a seed pod powder, and
mixing the seed pod powder with nutrient mixture comprising a bacterial growth medium,
wherein the plant in the genus Delonix is Deonix regia.

19. The method of claim 17, wherein
the combining is performed by mixing the support with a pellet of the bacterium in the genus Bacillus.

20. The method of claim 17, wherein
the combining is performed by
inoculating the support with an inoculation solution comprising the bacterium in the genus Bacillus; and
drying.
